(19) United States
(12) Patent Application Publication
(10) Pub. No.: US 2003/0009370 A1
(43) Pub. Date: Jan. 9, 2003

(54) Method and apparatus for customizing a multiple component pet food

(76) Inventors: Bhajmohan (Ricky) Singh, St. Louis, MO (US); Diane S. Kalishman, St. Louis, MO (US); Monique Nielsen, St. Louis, MO (US); Bryan Wilson Badger, Kirkwood, MO (US); Brigitte Martineau, St. Louis, MO (US); Robert Carvalho, Ballwin, MO (US)

Correspondence Address: John S. Beulick, Armstrong Teasdale LLP, One Metropolitan Sq., Suite 2600, St. Louis, MO, 63102, US

(21) Appl. No.: 09/881,935

(22) Filed: Jun. 15, 2001

(51) Int. Cl. G06F 17/60

(52) U.S. Cl. 705/10

(57) ABSTRACT

A method is provided for suggesting a pet food for a pet. The method includes obtaining an individual pet profile for the pet, processing the individual pet profile, suggesting a pre-manufactured kibble that correlates with the processed pet profile, suggesting a pre-manufactured additive that correlates with the processed pet profile, and providing a set of feeding instructions for the pet.

### BACKGROUND OF THE INVENTION

This invention relates generally to methods for manufacturing pet food, and more particularly, to a pet food including multiple parts, where at least one of the parts is customized for a particular pet.

Retail pet food manufacturers typically manufacture their pet foods in large quantities and in only a limited number of formulations. Most manufacturers offer, for example, dog food in several flavors, and in a puppy formula, an adult dog formula, and a mature or inactive dog formula. Some manufacturers offer breed-specific or size-specific formulas. In addition, some manufacturers offer more specialized formulas for dogs having specific food allergies or nutrient responsive diseases. Similarly, retail cat food is typically offered in a limited variety of formulas having different flavors or for different stages of development. However, all of the above described food selections are for a totally pre-made product and hence the range of pet food choices is not necessarily compatible with the highly variable preferences and dietary requirements of individual pets. Thus, making a selection to suit a particular pet's dietary needs is sometimes difficult and sub-optimal. For example, an individual pet may have specific dietary requirements because of an existing illness or disease, or because of a genetic predisposition towards a particular disease. Further, the existing variety of pet food choices typically available at, for example, retail outlets, makes it difficult for pet owners to choose the food which most closely meets their own pet's nutrient needs. In addition, once a food is chosen, knowing how to feed the food correctly can be difficult.

### BRIEF SUMMARY OF THE INVENTION

In one aspect, a method is provided for suggesting a pet food for a pet. The method includes obtaining an individual pet profile for the pet, processing the individual pet profile, suggesting a pre-manufactured kibble that correlates with the processed pet profile, suggesting a pre-manufactured additive that correlates with the processed pet profile, and providing a set of feeding instructions for the pet.

In another aspect, a method is provided for customizing a pet food for a pet. The method comprising obtaining an individual pet profile for the pet, processing the individual pet profile to create a pet food additive formula, suggesting a pre-manufactured kibble that correlates with the processed pet profile, and preparing a pet food additive derived from the created pet food additive formula.

In another aspect, an apparatus is provided for customizing a pet food product for a pet. The apparatus comprising means for obtaining an individual pet profile for the pet, means for processing the individual pet profile, means for creating a pet food additive formula in accordance with the processed individual pet profile, means for suggesting a pet food kibble in accordance with the processed individual pet profile, and means for producing a pet food additive in accordance with the pet food additive formula.

In another aspect, a method is provided for obtaining a customized pet food product for a pet. The method comprising providing information pertaining to an individual pet profile of the pet, obtaining a pre-manufactured kibble that correlates with the provided information, and obtaining a pet food additive derived from a pet food additive formula created utilizing the provided information.

### BRIEF DESCRIPTION OF THE DRAWINGS

FIG. 1 is a schematic illustration of an apparatus for producing a multiple part customized food.

FIG. 2 is a flow chart illustrating a method for producing a customized pet product in accordance with one embodiment of the invention.

FIG. 3 illustrates a method of obtaining a customized pet food product.

### DETAILED DESCRIPTION OF THE INVENTION

Exemplary embodiments of apparatus and methods for marketing customized pet products are described below. The apparatus and methods facilitate the manufacture of a pet food product that is directed to the specific needs of an individual pet. As used hereinafter, pet product includes pet foods as well as pet food components. Although the pet products may include food components that are manufactured in bulk, i.e., pre-made, the pre-made components are combined with either other pre-made components or with custom made products to produce an end product that is directed to the particular needs of an individual pet. In addition, although the method is often described in terms of a complete process, it should be understood that any portion of the process can be used separately or in combination with any other portion of the process described hereinafter.

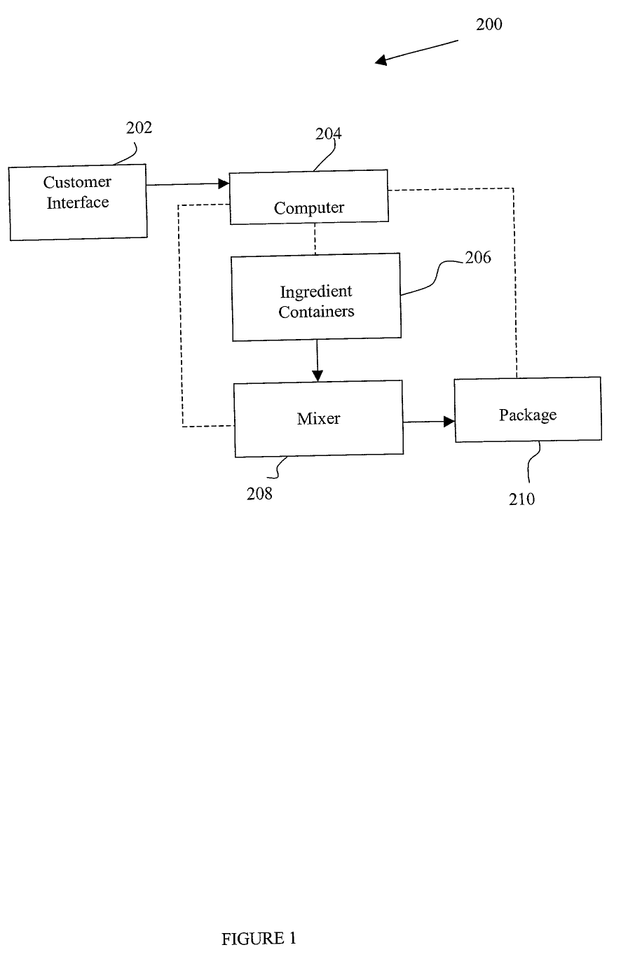

FIG. 1 is a schematic illustration of an exemplary embodiment of an apparatus 200 for producing a custom pet food product by matching a sauce with a base kibble. Apparatus 200 includes a customer interface 202 connected to a computer 204 for inputting a pet profile into computer 204. Computer 204 directs the proper combination of ingredients contained within ingredient containers 206 into a mixer 208. The mixed product is then packaged in a package 210.

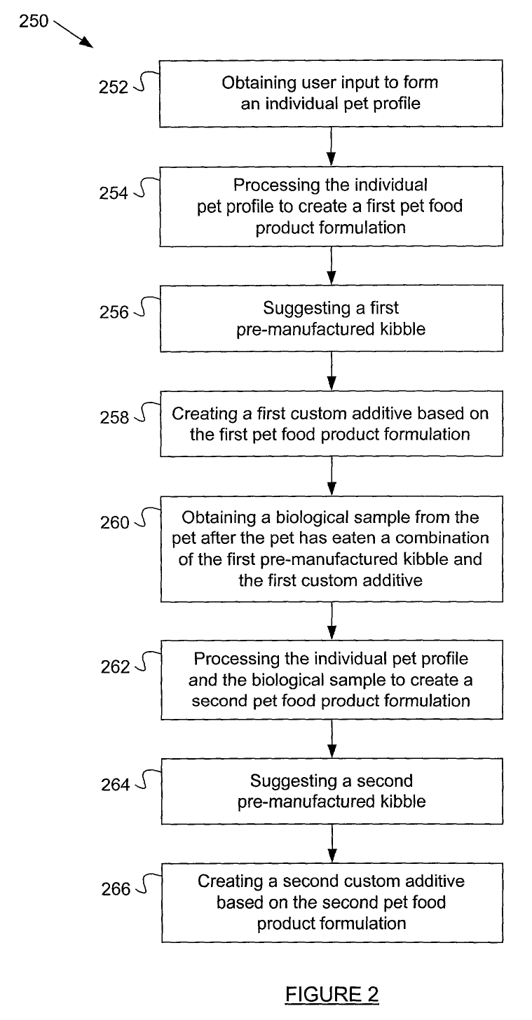

FIG. 2 is a flow chart of a method 250 for producing a custom pet food in accordance with an alternative embodiment of the invention. Method 250 generally includes obtaining user input, processing the obtained input, selecting an appropriate pre-manufactured kibble based on the obtained input, and preparing a custom food additive in accordance with the obtained user input.

The user input obtained is representative of an individual pet profile which includes nutritional and health information on a pet, and individual preferences of the pet and pet owner regarding finished product characteristics such as, size, shape, flavor, form, texture and the like. Although method 250 is described below in the context of an electronic system, it should be understood that the user input can occur through any means, electronic or otherwise and the processing can occur through any means, electronic or otherwise. For example, method 250 may be practiced by administering a written or verbal questionnaire to a user or customer to create the individual pet profile, using the individual pet profile to generate a customized pet product formula, and producing the customized pet product.

In an exemplary embodiment, a user such as a consumer connects to a computer via a computer network such as the Internet, from a home computer connected to a home phone line. Alternatively, the user uses a user interface local relative to the computer. In one embodiment, the computer and the user interface are located in a retail grocery store. The computer provides an electronic input to the user interface. The user input is obtained 252 to form an individual pet profile by prompting a user at the user interface to answer a series of questions to form the individual pet profile of the pet. The answers from the user are communicated electronically to the computer which processes the information contained in the individual pet profile. The processed information is used to create 254 a first pet food product formulation for a first pet food product. In one embodiment, the custom pet food product includes a pre-manufactured kibble and a custom pet food additive. The computer suggests 256 a first pre-manufactured kibble from a number of possible pre-manufactured kibbles and creates 258 a first pet food additive based on the pet food product formulation specific to the pet and in accordance with the individual pet profile of the pet. In an alternative embodiment, the pet food product includes a pre-manufactured kibble and a pre-manufactured additive, such as a sauce. The computer suggests a particular pre-manufactured kibble from a number of possible pre-manufactured kibbles and suggests a particular pre-manufactured sauce from a number of possible pre-manufactured sauces.

The individual pet profile is composed of answers to questions pertaining to, but not limited to, a pet's name, species, age, weight, gender, breed, spayed/neutered, activity level, breeding status, medical history and genetic information, current health status, body condition, feeding method, snack schedule and flavor preferences. In alternative embodiments, the individual pet profile includes indications regarding, for example, the preferences of the pet, or the pet's owner, regarding form, flavor, shape and texture and information regarding the season, or time of year. In one embodiment, the user is a consumer such as a pet owner. In an alternative embodiment, the user is a pet care provider such as a veterinarian or veterinary technician who administers a written questionnaire to the pet owner, and then supplies the data to the computer. The computer receives and processes the information contained in the individual pet profile and stores the information in a database.

In addition to the individual pet profile created based on user input, the user is also requested to input information obtained from a biological sample of the pet. The computer utilizes information obtained from the biological sample analysis to obtain additional information regarding the pet. The information regarding the biological sample analysis can be obtained by any means and is not limited to electronic means. In an exemplary embodiment, the additional information regarding the biological sample analysis is pertinent to determining the pet's individual ability to react to specific dietary nutrients or ingredients and thereby change the health status of the pet (including, but not limited to stool quality, immune status, oral/dental health, skeletal health, skin and coat condition). In one embodiment, the analysis of the biological sample is obtained at the same time the pet profile information is obtained. In an alternative embodiment, the analysis of the biological sample is obtained 260 after the pet has eaten, for a predetermined period of time, a combination of the first pre-manufactured kibble and the first custom additive produced in accordance with the individual pet profile information. The analysis provides information that enhances the individual pet profile information and is used to modify and refine the customized pet food product by suggesting a different pre-manufactured kibble, adding specific additive ingredients, removing specific additive ingredients, and/or changing the amount of any included additive ingredient from the pet product formulation to enable the new formulation to better meet the needs of the pet. In one embodiment, the additional nutritional and biological analyses information is conveyed to the pet's veterinarian to recommend potential therapeutic components to the diet or a therapeutic treatment if appropriate. In an alternative embodiment, the nutritional and biological analyses information is conveyed by the veterinarian to a pet food manufacturer. In the exemplary embodiment, the biological sample includes, but is not limited to, at least one of stool, urine, hair, blood, saliva, tissue, and DNA.

The biological sample analysis determines a pet's individual reaction to a diet and the pet's ability to change its health status, including, but not limited to stool quality, immune status, oral/dental health, skeletal health, skin and coat health. The pet's individual reaction and ability to change may be different than a reaction of another pet in the same category to the same diet. For example, in creating pet foods for the “average” dog, digestion tests are typically conducted on a statistically large group of animals and their reactions averaged. The predictions are made on how these diets may fare for other similar dogs. Individual variations are thus excluded during creating foods for the “average” pet. It is these individual variations that are addressed by using method 250.

The computer includes a database that stores the individual pet profile, nutritional information, and biological sample analysis information. The individual pet profile and the biological sample analysis information are processed 262 to create a second pet product formulation specific to the individual pet. In one embodiment, the nutritional information is combined with the individual pet profile and the biological sample analysis information to create the pet food product formulation specific to the individual pet, which is also stored in the database. In addition, the computer is programmed to assemble the user input and nutritional data into printed material. In an exemplary embodiment, the printed material includes customized pet feeding and care information for the individual pet, along with an ingredient statement, guaranteed analysis of the pet food, and a product label. In alternative embodiments, the printed material may also include recommendations regarding the use of treats and supplements, exercise of the pet, and veterinary care.

In one embodiment, the second pet food product includes a second pre-manufactured kibble and a second custom pet food additive. The computer suggests 264 a second pre-manufactured kibble from a number of possible pre-manufactured kibbles and creates 266 a second pet food additive based on the pet food product formulation specific to the pet and in accordance with the individual pet profile of the pet. In an alternative embodiment, the second pet food product includes a pre-manufactured kibble and a pre-manufactured additive, such as a sauce. The computer suggests a particular pre-manufactured kibble from a number of possible pre-manufactured kibbles and suggests a particular pre-manufactured sauce from a number of possible pre-manufactured sauces.

In one embodiment, the customized pet product includes a first basal portion common to many types of finished food products and also includes a second supplemental portion that incorporates additional ingredients. The additional ingredients, in one embodiment, are in the form of a sauce, a coating, a gravy, a solution, a topping, and a powder. In alternative embodiments, the additional ingredients can take other forms. The two-portion food provides a large variety of customized foods while keeping the inventory of basal ingredients and supplemental ingredients to a minimum. Only a minimal number of ingredients are utilized since a minimum number of nutrient bases (for the major categories of pet foods) can be used in conjunction with micro ingredients such as vitamins, minerals, fats, antioxidants, flavors, soluble fibers, and other functional ingredients to provide a large variety of complete, customized pet foods that address a pet's specific nutritional and other needs.

In an exemplary embodiment, the basal food portion is pre-made into kibbles and an additive is custom blended according to each pet's specific individual pet profile and biological sample analysis. A set of dog nutrient profiles, with the exception of fat, soluble fiber, and vitamin E, is created to satisfy the macronutrient needs of different dogs. For example, a set of 10 profiles is utilized to create 10 formulas, e.g., F1 through F10. These formulas are utilized to manufacture, according to known extrusion methods, pre-made kibbles which are packaged into packages, such as bags.

Next, an additive formulation, such as a sauce, is formulated in a number of varieties, e.g., S1 through S25, which provide the required amounts of fat, fiber, and vitamin E. The additive formulations are created to make each of the bases F1 through F10 complete and balanced when mixed with an appropriate additive in an appropriate amount. Additives S1 through S25 are made in any of the consumer-preferred flavors and with inclusions of other desired micronutrients. Thus, the total number of additives increases by a factor such as four.

For example, additive S3 (at 12.5% of total) is combined with formula F5 (at 87.5% of total) to create a complete and balanced food that provides all the nutrient needs of a specific pet. Additive S3 is, for example, a sauce having a salmon flavor and other desired micronutrients, such as extra vitamin E for a stressful dog. Multiple additives can be formulated to be compatible with multiple pre-made bases.

In one embodiment, the pre-made bases, F1 through F10, are packaged in bags and brought to a store. Components, such as flavors, micro-nutrients, fats, soluble fiber, and preservatives, to make the additives S1 through S25 are also brought to the same store in containers, such as dispensing bottles. As a customer's requirements are determined, a specific base, such as F3, is selected and an additive formulation, say F5, in a customer chosen flavor, say tuna flavor, is created on site. Using the dispensing bottles, the additive is mixed in a bottle, sealed, and given to the consumer with proper mixing and feeding instructions. The user combines the kibbles with the additive to provide a customized pet food to the pet. In one embodiment, the additive is one of a sauce, a powder, a coating, a thickener, a topping and a gravy. In alternative embodiments, the additive is a combination of two or more of the above listed additives.

The additives are formulated such that when the additives are combined with the kibbles, a complete, balanced and customized nutritious product is supplied. In one embodiment, the additives are manufactured by an operator in accordance with information obtained from the pet's individual pet profile.

The ratio of additives to kibbles is an important factor in supplying a complete and nutritious food to pets. The macronutrients in a pet food (such as the protein, carbohydrates, fat and moisture) are provided to a large extent by the base kibbles. However, the caloric and fat content of the combined food can be adjusted by manipulating the fat content of the additives. Thus, for an additive added at 12.5% of the total pet food (base plus additive), the fat content of the additive is varied between 15% and 70%. This variation allows addition of between 2% and 11% fat, and selecting the appropriate level of fat in the additive allows fat levels of the combined pet food to vary between about 4% and 20% which is a typical range for pet foods.

All pets need the vitamins and minerals that make up a complete and balanced diet. These vitamins and minerals are usually sourced as premixes from vitamin suppliers and are added at typically less than 1% of the formulation. In one embodiment, these vitamins and minerals are added to the kibbles. In an alternative embodiment, for vitamins and minerals that need to be protected from high thermal processing such as extrusions, the vitamins and minerals are added to the additives instead. Higher dosages of vitamins such as Vitamin E and Vitamin C are suggested for individual dogs that are senior, active, or undergoing immune deficiency. Higher than basic levels of these vitamins can be delivered through addition of vitamins in the additives, typically at low levels such as from 0 to 0.5%.

In addition, if dogs need additional levels of soluble or insoluble fiber, the fiber is delivered through the additives in amounts typically ranging between 0.1% and 1.0% of the total formulation, or between 0.5% and 20% of the sauce depending upon the sauce to the base kibble ratio.

Palatable coatings such as animal digests, typically used in pet food formulations, can be used to make the sauce highly palatable to the pets. These coating levels can be varied (0.5% to 10%) to compensate for the varying palatability effect of other ingredients such as fat levels. Thus, even low-calorie pet foods can be made as palatable as high-calorie foods by adding an extra amount of palatable coatings to the kibbles in a low-calorie diet.

Other specialized micronutrients, as they are discovered for their effect in pet nutrition can also be delivered through the additives as a delivery mechanism. For example, fish oil as a source of omega three fatty acids for healthy skin and coat, is included in the additives in the required quantities (such as between 0 and 5%). Alternatively, sodium acid pyrophosphate for dental and skeletal health is included in the additives in the required quantities (such as between 0 and 5%).

In addition, and in one embodiment, the additives are visually appealing and functionally stable. For example, pH lowering agents (such as phosphoric acid or sodium bisulfate and/or Sorbic acid) are added at between 1.0% and 5.0% to bring the pH to between 2.0 and 3.0 to provide a resistance to bacterial, fungal or other microbial spoilage to the additives. Additive stabilizers, for example for a sauce, such as gums or fibers are, in one embodiment, added at between 0.5% and 2.0% to make the additive components well integrated. Other flavors and colors are added at 0 to 3.0% to provide the desired flavor and color of the additive to the customer. For a sauce additive, it has been determined that adding Psyllium fiber at between 0 and 1.0% of the sauce amount binds water and prevents separation of aqueous and fat phases in the sauce.

In an alternative embodiment, the kibbles are not pre-manufactured but instead the basal food portion is pre-mixed and transported to specific locations, such as retail locations. Ingredients to make the supplemental portion are kept at each retail location. Manufacturing apparatus at each specific location are utilized to blend the appropriate supplemental ingredients with the pre-made basal portion and form a manufactured food. Thus the manufacturing process is simplified and can be diffused to many locations instead of one or a few central locations.

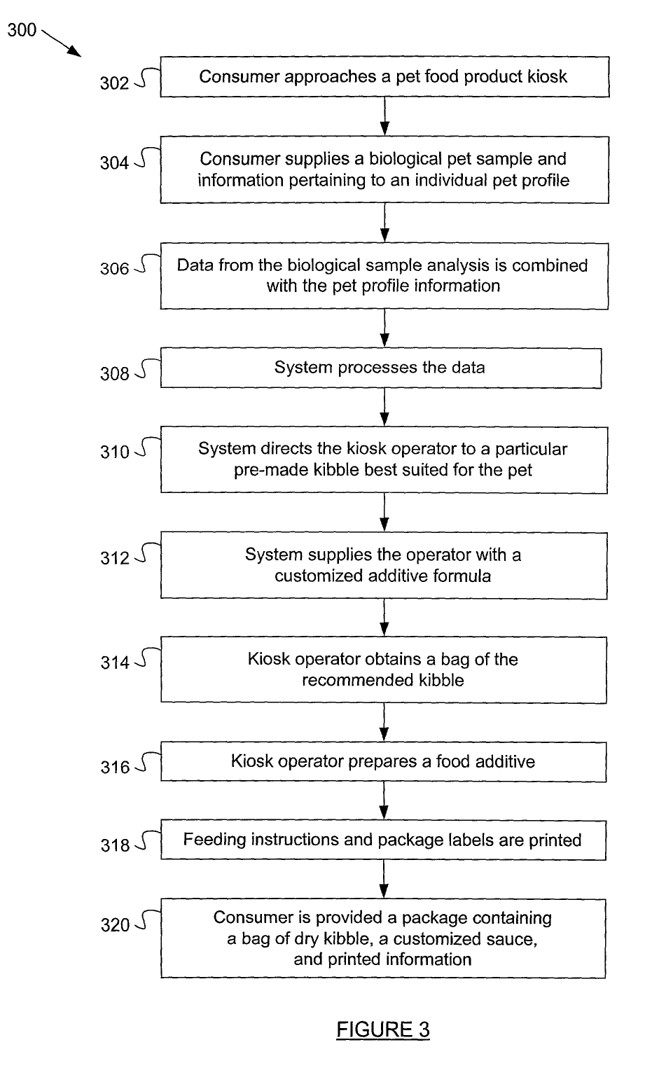

FIG. 3 illustrates a method 300 of obtaining a customized pet food product. In an exemplary embodiment, a pet owner (consumer) that is a first-time purchaser of a customized pet food product approaches 302 pet food product kiosk, or booth, located in a retail location, including but not limited to, a mall, a store, a veterinarian office, a clinic, an airport, and an outdoor event. The consumer supplies 304 a biological sample (i.e., stool sample) and information pertaining to an individual pet profile. In one embodiment, the consumer supplies a completed questionnaire which is obtained in advance of the visit, such as via the Internet, in the mail, or which is personally picked up at the kiosk.

In one embodiment, analytical data is obtained from the biological sample by a veterinarian/technician located on site. In an alternative embodiment, the sample is sent to a central lab for analysis. The analysis is performed on the biological sample with respect to examining several health and digestive indicators. Data from the biological sample analysis is combined 306 with the pet profile information and entered into a system including a pet food product customization model. Alternatively, the biological sample analysis is forward by the pet's veterinarian to the kiosk operator and the results are incorporated into the pet profile.

The system processes 308 the data utilizing at least one algorithm and generates a pet profile. Each profile has a unique identifying code and contains the specific customized food product and feeding instructions recommended for the specific pet. The recommended food product includes a pre-manufactured kibble and a customized additive. In one embodiment, the pre-manufactured kibble is selected from a variety of pre-manufactured kibbles and the additive is a liquid additive that is made on site, typically in the presence of the consumer. The system directs 310 the kiosk operator to the particular pre-made kibble best suited for the pet and supplies 312 the operator with a customized additive formula that has been created based upon the individual pet's profile. Alternatively, the system indicates a recommendation for the pet to see a veterinarian prior to buying a customized food, if certain “warning” signs are present in the profile. This recommendation provides the consumer with added health information about the pet between regular vet visits.

The kiosk operator then obtains 314 a bag of the recommended kibble and prepares 316 a food additive, including but not limited to a sauce, a gravy, a topping, a thickener, a powder, and a coating, utilizing the customized additive formula. In the exemplary embodiment, a sauce is made. In addition, customized feeding instructions and package labels are printed 318. The consumer is provided 320 a package containing a bag of dry food base, a bottle of customized sauce, printed information, a customized measuring scoop for the dry kibbles and a custom-selected spoon for measuring the sauce into the food bowl. Additionally, the consumer receives information about the recommended frequency and conditions of future biological sample analyses and/or profile updates for their pet.

In an alternative embodiment, the pet profile is utilized by the system to direct the kiosk operator to a pre-manufactured kibble best suited for the pet and a pre-manufactured sauce best suited for the pet. The kiosk operator provides the consumer with the appropriate pre-manufactured kibble and pre-manufactured sauce and the consumer mixes the appropriate amounts of each for the pet.

For a repeat purchase, a consumer returns to the kiosk and provides their pet's unique code to access their pet's profile. They may update/change the profile information and/or provide a new biological sample, either of which could result in a different recommended food. Alternatively, the consumer leaves the profile as it is and replenishes their pet's current food supply.

In an alternative embodiment, the additive is ordered by at least one of mail, catalogue, and the Internet, and is shipped directly to the consumer's home. Then, only the pre-made bases are purchased at a retail outlet. Once the consumer receives a base formula recommendation, the consumer purchases the base wherever convenient, and the additive is shipped directly to the consumer in finished or almost finished form. In one embodiment, the consumer adds one of water and oil to the shipped sauce. In alternative embodiments, the sauce is produced either on site or off site and the production is either manual or automated.

### EXAMPLE 1

A pet questionnaire is administered regarding a pet named “Bruno” at a remote manufacturing location, such as a retail store. The questionnaire is completed by Bruno's owner and the following information, among other information, is obtained about Bruno.

| | |
|---|---|
| Name of pet: | Bruno |
| Breed of Pet: | Golden Retriever |
| Weight: | 65 lbs |
| Age: | 4 Years |
| Gender: | Male |
| Spayed/Neutered: | Yes |
| Activity Level: | Moderate |
| Season: | Summer |
| Feeding Method: | Measured |
| Snack Schedule: | Once a day |
| Flavor Preference: | Chicken for Base and Beef Stew for Sauce |
| Body Condition: | Ideal/Fit |

Next, Bruno's owner delivers a typical stool sample of Bruno to the retail store where the feeding and care program is being administered. The following stool sample analyses of Bruno is performed.

| | |
|---|---|
| Moisture: | Normal |
| Texture: | High-Above Normal |
| Discomfort: | Yes |
| Particulates: | None |
| Color: | Normal |
| Mucin: | None to Normal |
| Parasites: | None |

Based on the above information, a pre-manufactured kibble (Base B2) is selected that is appropriate for adult, medium sized dogs with a moderate level of activity, good body condition score, the desired flavor preference and no other special health condition. Based on the kibble selected, a pre-manufactured sauce is selected (S4) which is appropriate for dogs with hard stool and/or fecal straining issues. The sauce is formulated to be distributed in a 10 oz. bottle and to complement a 5 lb. bag of dry kibble. The sauce's composition is:

| | |
|---|---|
| Sauce Percentage | 12.50% |
| Base Code | B2 (Adult) |
| Sauce Code | S4 Overweight w/Fiber |
| Formula No. | Beef Stew |

| Ingredient Name | Step % | Formula % | Grams |
|---|---|---|---|
| Animal Digest | 15.2% | 1.90% | 48.6 |
| Sodium Bisulfate | 3.8% | 0.48% | 12.2 |
| Deionized Water | 56.2% | 7.03% | 180.0 |
| Sorbic Acid | 0.2% | 0.02% | 0.6 |
| Psyllium | 0.6% | 0.07% | 1.8 |
| Corn Oil | 16.00% | 2.00% | 51.2 |
| Lactulose | 8.00% | 1.00% | 25.6 |
| Beef Stew Flavor | 0.20% | 0.03% | 0.6 |
| Total Percentage | 100.0% | 12.50% | 320.6 |

Next, an appropriate daily feeding amount is calculated based on the nutrient profile and “sauce” selected, the weight of the dog, body condition, season of the year and snacking habit. Both the pre-manufactured kibble and the pre-manufactured sauce are given to the owner with feeding instructions and a copy of the above report. A copy of the individual pet profile and sample stool test is sent to Bruno's veterinarian.

The above described methods for customizing pet foods and pet products provide a way for pet food manufacturers to address the individualized health and nutrition requirements, and preferences, of individual pets and their owners. For example, the customized pet food and pet products can be tailored to provide a desired nutritional balance for a pet of a specific age, gender and weight, at a particular time of year, and having a specific health problem, such as, for example, a food allergy. In one embodiment, application of the methods to electronic telecommunications and data processing devices enable pet food manufacturers to provide customized pet food to users located at numerous facilities or locations, including for example, homes, veterinary offices, retail grocers and retail pet stores. The customized pet food can be delivered to the user at the site of manufacture, or manufactured at a site remote from the user and shipped or mailed to the user.

While the invention has been described in terms of various specific embodiments, those skilled in the art will recognize that the invention can be practiced with modification within the spirit and scope of the claims.

What is claimed is:

1. A method for suggesting a pet food for a pet, said method comprising:
obtaining an individual pet profile for the pet;
processing the individual pet profile;
suggesting a pre-manufactured kibble that correlates with the processed pet profile;
suggesting a pre-manufactured additive that correlates with the processed pet profile; and
providing a set of feeding instructions for the pet.

2. A method in accordance with claim 1 wherein providing a set of feeding instructions comprises:
providing information regarding the proper amount of additive to feed the pet; and
providing information regarding the proper amount of kibbles to feed the pet.

3. A method in accordance with claim 2 further comprising providing information on whether additional components should be added to the pet food.

4. A method for customizing a pet food for a pet, said method comprising:
obtaining an individual pet profile for the pet;
processing the individual pet profile to create a pet food additive formula;
suggesting a pre-manufactured kibble that correlates with the processed pet profile; and
preparing a pet food additive derived from the created pet food additive formula.

5. A method in accordance with claim 4 further comprising providing a set of feeding instructions for the pet.

6. A method in accordance with claim 5 wherein providing a set of feeding instructions comprises:
providing information regarding the proper amount of additive to feed the pet; and
providing information regarding the proper amount of kibbles to feed the pet.

7. A method in accordance with claim 6 further comprising providing information on whether additional components should be added to the pet food.

8. Apparatus for customizing a pet food product for a pet, said apparatus comprising:
means for obtaining an individual pet profile for the pet;
means for processing the individual pet profile;
means for creating a pet food additive formula in accordance with the processed individual pet profile;
means for suggesting a pet food kibble in accordance with the processed individual pet profile; and
means for producing a pet food additive in accordance with the pet food additive formula.

9. Apparatus in accordance with claim 8 wherein said means for obtaining an individual pet profile comprises receiving information from a pet profile questionnaire.

10. Apparatus in accordance with claim 8 wherein said means for processing the individual pet profile and the biological sample analysis comprises a computer configured to process the individual pet profile and combine the processed information with stored nutritional information to suggest a pet food product.

11. A method for obtaining a customized pet food product for a pet, said method comprising:
providing information pertaining to an individual pet profile of the pet;
obtaining a pre-manufactured kibble that correlates with the provided information; and
obtaining a pet food additive derived from a pet food additive formula created utilizing the provided information.

12. A method for creating a customized pet food additive formula for a pet, said method comprising:
receiving, through an electronic interface, a user input comprising an individual pet profile for the pet;
receiving an analysis from a biological sample of the pet after the pet has been eating a pet food manufactured according to the first pet food formula;
electronically processing the individual pet profile and the biological sample analysis to create a pet food additive formula utilizing information obtained from the user input individual pet profile and the biological sample analysis; and
electronically processing the individual pet profile and the biological sample analysis to suggest a pre-manufactured kibble utilizing information obtained from the user input individual pet profile and the biological sample analysis.

13. A method for supplying a pet food for a pet, said method comprising:
obtaining an individual pet profile for the pet;
processing the individual pet profile
supplying a pre-manufactured kibble based on the processed individual pet profile;
creating a custom pet food additive based on the processed individual pet file; and
supplying the custom pet food additive.

14. A method in accordance with claim 13 wherein obtaining an individual pet profile comprises obtaining at least one of species, activity level, medical history, breed, gender, breeding status, feeding method, age, spayed/neutered status, snack schedule, flavor preference, body condition and weight of the pet.

15. A method in accordance with claim 13 wherein obtaining an individual pet profile comprises obtaining answers to a plurality of questions regarding individual attributes of the pet.

16. A method in accordance with claim 13 wherein obtaining an individual pet profile comprises obtaining answers to a plurality of questions regarding preferences of an owner of the pet.

17. A method in accordance with claim 13 wherein creating a custom pet food additive based on the processed individual pet file comprises creating at least one of a gravy, a sauce, a coating, a thickener, a topping and a powder.

18. A method in accordance with claim 13 wherein creating a custom pet food additive comprises adding Psyllium fiber to the additive.

19. A method in accordance with claim 18 wherein adding Psyllium fiber comprises adding between 0 and 1.0% Psyllium fiber be weight in the additive.

20. A method in accordance with claim 18 wherein adding Psyllium fiber comprises adding a sufficient quantity of Psyllium fiber to bind water and prevent separation of aqueous and fat phases in the sauce.

21. A method in accordance with claim 13 wherein creating a custom pet food additive comprises adding a pH lowering agent to bring the pH between about 2.0 and about 3.0.

22. A method in accordance with claim 13 wherein creating a custom pet food additive comprises adding a substance to the pet food additive to provide resistance to at least one of bacterial, fungal, and other microbial spoilage.

23. A method in accordance with claim 13 wherein creating a custom pet food additive comprises adding a source of omega three fatty acids to the additive.

24. A method in accordance with claim 13 wherein creating a custom pet food additive comprises adding sodium acid pyrophosphate for dental and skeletal health to the additive.

25. A method in accordance with claim 13 wherein creating a custom pet food additive comprises adding a palatability agent to the additive.

26. A method in accordance with claim 13 wherein creating a custom pet food additive comprises adding a source of fiber to the additive.

27. A method in accordance with claim 13 wherein creating a custom pet food additive comprises adding a source of at least one of vitamins and minerals to the additive.

28. A method in accordance with claim 13 comprises supplying the appropriate ratio of kibbles to additive.
